(19) United States
(12) Patent Application Publication
(10) Pub. No.: US 2003/0081563 A1
(43) Pub. Date: May 1, 2003

(54) Method and radio system for digital signal transmission

(76) Inventors: Ari Hottinen, Espoo (FI); Olav Tirkkonen, Helsinki (FI)

Correspondence Address: PILLSBURY WINTHROP, LLP, P.O. BOX 10500, MCLEAN, VA, 22102, US

(21) Appl. No.: 10/225,457

(22) Filed: Aug. 22, 2002

Related U.S. Application Data
(63) Continuation of application No. PCT/FI01/00166, filed on Feb. 20, 2001.

(30) Foreign Application Priority Data
Feb. 22, 2000 (FI) 20000406

(51) Int. Cl. H04B 7/216

(52) U.S. Cl. 370/320; 370/335

(57) ABSTRACT

The invention relates to a method and an arrangement for transmitting a digital signal consisting of symbols, which arrangement comprises a coder (308) for coding complex symbols to channel symbols in blocks having the length of a given K, means (312) for transmitting the channel symbols via several different channels and two or more antennas (314 to 318). The coder (308) is arranged to code the symbols using a code matrix, which can be expressed as a sum of 2K elements, in which each element is a product of a symbol or symbol complex conjugate to be transmitted and a N×N representation matrix of a complexified anticommutator algebra, extended by a unit element, and in which each matrix is used at most once in the formation of the code matrix.

This application is a Continuation of International Application PCT/FI01/00166 filed on the Feb. 20, 2001, which designated the U.S. and was published under PCT Article 21(2) in English.

### FIELD OF THE INVENTION

The invention relates to a method and a radio system for transmitting a digital signal in a radio system, particularly in a mobile communication system. In particular the invention relates to the use of transmit diversity.

### BACKGROUND OF THE INVENTION

In telecommunication connections, the transmission path used for transmitting signals is known to cause interference to telecommunication. This occurs regardless of the physical form of the transmission path, i.e. whether the transmission path is a radio link, an optical fibre or a copper cable. Particularly in radio telecommunication there are frequently situations where the quality of the transmission path varies from one occasion to another and also during a connection.

Radio path fading is a typical phenomenon that causes changes in a transmission channel. Other simultaneous connections may also cause interferences and they can vary as a function of time and place.

In a typical radio telecommunication environment the signals between a transmitter and a receiver propagate on a plurality of routes. This multipath propagation mainly results from signal reflections from surrounding surfaces. The signals that propagated via different routes reach the receiver at different times due to different propagation time delays. Various methods have been developed in order to compensate the fading caused by this multipath propagation.

One solution to the problem is the use of diversity at the transmission end of the connection. In time diversity, interleaving and coding are used, which cause temporal diversity to a signal to be transmitted. There is a disadvantage, however, that there will be delays in the transmission, especially when it deals with a slowly fading channel. In frequency diversity, on the other hand, a signal is transmitted simultaneously at different frequencies. This is, however, an ineffective method when the coherence bandwidth of the channel is big.

In antenna diversity the same signal is transmitted to a receiver by using two or more antennas. In this case, signal components that have multipath-propagated through different channels will probably not be disturbed by the simultaneous fading.

The publication WO 99/14871 discloses a diversity method in which the symbols to be transmitted, consisting of bits, are coded in blocks of a given length and in which each block is coded to a given number of channel symbols to be transmitted via two antennas. A different signal is transmitted via each antenna. For example, when the symbols to be coded are divided into blocks having the length of two bits, the channel symbols to be transmitted are formed such that the channel symbols to be transmitted via the first antenna consist of a first symbol and a complex conjugate of a second symbol, and the channel symbols to be transmitted via the second antenna consist of the second symbol and a complex conjugate of the first symbol. The described solution is, however, only applicable when two antennas are used. The solution is called space-time block coding.

The publications Tarokh, V., Jafarkhani, H., Calderbank, A. R.: Space-Time Block Codes from Orthogonal Designs, IEEE Transactions on information theory, Vol. 45 pp.1456-1467, July 1999 and Tarokh, V., Jafarkhani, H., Calderbank, A. R.: Space-Time Block Coding for Wireless Communications: Performance Results, IEEE Journal on Selected Areas In Communication, Vol. 17 pp. 451-460, March 1999, disclose corresponding solutions which can be applied to more than two antennas. As an example, the code of the code rate ¾ is given:

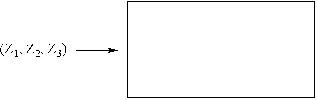

In space-time coding, the most essential criteria in code selection are the achieved diversity, code rate and delay. Diversity can be described by the number of channels to be decoded independently, and for full diversity this means the same as the number of transmit antennas. The code rate is the ratio of space-time coded signal velocity to signal velocity that is coded only temporally. Delay, for its part, is the length of a space-time block. Depending on the modulation method used, either a term real coding or complex coding is used.

When complex modulation is used, full diversity codes with a code rate 1 are only described in connection with two antennas (in the publication WO 99/14871). The above publication presents a rate ½ code which is constructed from the full rate real code by setting the complex signals on top of the same, but conjugated signals. This way rate ½ codes for two to eight antennas are obtained. In the following, an example of a code for three antennas is given:

$$( {z}_{1} , {z}_{2} , {z}_{3} , {z}_{4} ) \to [ \begin{matrix}{z}_{1} & {z}_{2} & {z}_{3} \\ - {z}_{2} & {z}_{1} & - {z}_{4} \\ - {z}_{3} & {z}_{4} & {z}_{1} \\ - {z}_{4} & - {z}_{3} & {z}_{2} \\ {z}_{1}^{*} & {z}_{2}^{*} & {z}_{3}^{*} \\ - {z}_{2}^{*} & {z}_{1}^{*} & - {z}_{1}^{*} \\ - {z}_{3}^{*} & {z}_{4}^{*} & {z}_{1}^{*} \\ - {z}_{4}^{*} & - {z}_{3}^{*} & {z}_{2}^{*}\end{matrix} ]$$

where a star (*) refers to a complex conjugate. These codes are not delay-optimal.

So far, all complex space-time block codes have belonged to two categories: a group based on real codes, halving the code rate, such as the above example, or a group based on square unitary matrices.

‘Open-loop diversity’ should have these four properties:

1. Full diversity in regard to the number of antennas.

2. Only linear processing is required in a transmitter and a receiver.

3. Transmission power is divided equally between the antennas.

4. The code rate efficiency is as high as possible.

A drawback of the above solutions is that only the requirements 1 and 2 can be fulfilled. For example, the transmission power of different antennas is divided unequally, i.e. different antennas transmit at different powers. This causes problems in the planning of output amplifiers. Furthermore, the code rate is not optimal.

### BRIEF DESCRIPTION OF THE INVENTION

It is thus an object of the invention to implement a method and a system by which optimal diversity is achieved with different numbers of antennas. This is achieved by a method of transmitting a digital signal consisting of symbols, which method comprises the steps of coding complex symbols to channel symbols in blocks having the length of a given K and transmitting the channel symbols via several different channels and two or more antennas. In the method of the invention, coding is performed such that the coding is defined by a code matrix, which can be expressed as a sum of 2K elements, in which each element is a product of a symbol or symbol complex conjugate to be transmitted and a N×N representation matrix of a complexified anticommutator algebra, extended by a unit element, and in which each matrix is used at most once in the formation of the code matrix.

Further, in the method of the invention the coding is performed such that the coding is defined by a code matrix which is formed by freely selecting 2K−1 unitary, antihermitean N×N matrices anticommuting with each other, forming K−1 pairs of said matrices, whereby the remaining matrix forms a pair with an N-dimensional unit matrix, forming two matrices of each pair such that the second matrix of the pair, multiplied by the imaginary unit, is added to and subtracted from the first matrix of the pair, and in which each matrix formed in the above manner defines the dependence of the code matrix on one symbol or symbol complex conjugate to be coded.

The invention also relates to an arrangement for transmitting a digital signal consisting of symbols, which arrangement comprises a coder for coding complex symbols to channel symbols in blocks having the length of a given K, means for transmitting the channel symbols via several different channels and two or more antennas. In the arrangement of the invention, the coder is arranged to code the symbols using a code matrix, which can be expressed as a sum of 2K elements, in which each element is a product of a symbol or symbol complex conjugate to be transmitted and a a N×N representation matrix of a complexified anticommutator algebra, extended by a unit element, and in which each matrix is used at most once in the formation of the code matrix.

Furthermore, in the arrangement of the invention the coder is arranged to code the symbols using a code matrix which is formed by freely selecting 2K−1 unitary, antihermitean N×N matrices anticommuting with each other, forming K−1 pairs of said matrices, whereby the remaining matrix forms a pair with an N-dimensional unit matrix, forming two matrices of each pair such that the second matrix of the pair, multiplied by the imaginary unit, is added to and subtracted from the first matrix of the pair, and in which each matrix formed in the above manner defines the dependence of the code matrix, on one symbol or symbol complex conjugate to be coded.

The solution of the invention can provide a system in which any number of transmit and receive antennas can be used and a full diversity gain can be achieved by space-time block coding. In a preferred embodiment, the maximal code rate and the optimal delay are achieved by square codes having a dimension that is a power of two.

The solution of the invention employs complex block codes. In a preferred embodiment codes are used, which are based on matrices whose all elements have the form of ±zₖ, ±z*ₖ or 0. The prior art solutions reveal no codes in whose elements the term 0 appears. First, square codes are given, from which non-square codes are obtained by eliminating columns (antennas). In these codes known as basic codes the elements depend only on one symbol, or on the real part of a symbol and the imaginary part of another symbol. In another preferred embodiment, full diversity codes which do not have the above restriction can be used.

An equal distribution of transmission power between different antennas is also achieved by means of the solution of the invention. The solution of the invention preferably also provides coding in which the ratio of the maximum power to the average power or the ratio of the average power to the minimum power can be minimized.

### BRIEF DESCRIPTION OF THE DRAWINGS

In the following the invention will be described in greater detail in connection with the preferred embodiments, with reference to the attached drawings, in which

FIG. 1 shows an example of a system according to a preferred embodiment of the invention,

FIG. 2 shows another example of a system according to a preferred embodiment of the invention, and

FIG. 3 illustrates an example of an arrangement according to a preferred embodiment of the invention.

### DETAILED DESCRIPTION OF THE PREFERRED EMBODIMENTS

The invention can be used in radio systems which allow the transmission of at least a part of a signal by using at least three or more transmit antennas or three or more beams that are accomplished by any number of transmit antennas. A transmission channel may be formed by using a time division, frequency division or code division multiple access method. Also systems that employ combinations of different multiple access methods are in accordance with the invention. The examples describe the use of the invention in a universal mobile communication system utilizing a broadband code division multiple access method implemented with a direct sequential technique, yet without restricting the invention thereto.

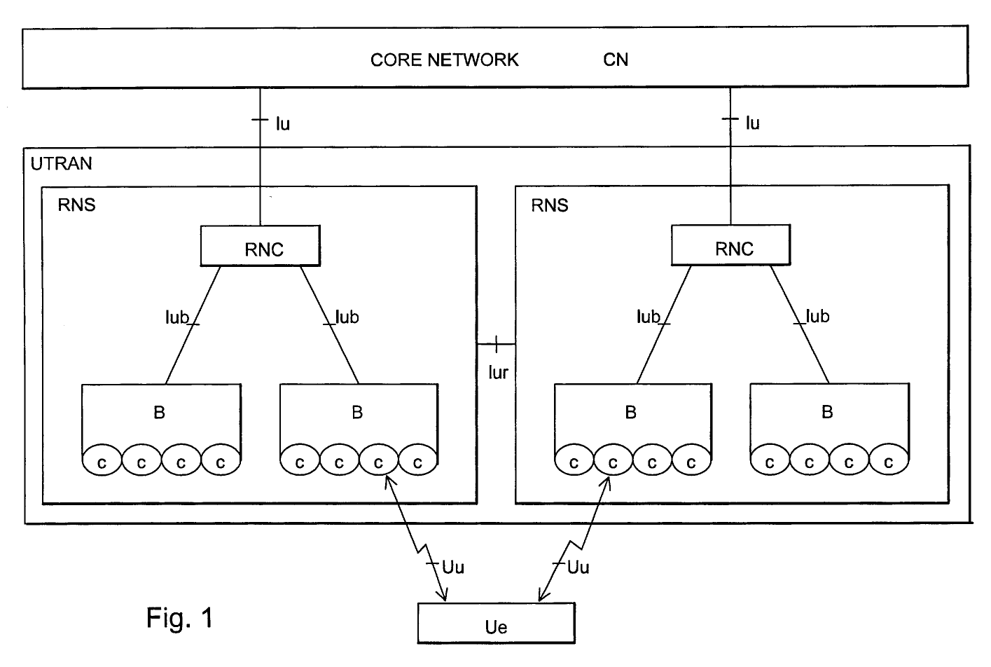

Referring to FIG. 1, a structure of a mobile communication system is described by way of example. The main parts of the mobile communication system are core network CN, UMTS terrestrial radio access network UTRAN and user equipment UE. The interface between the CN and the UTRAN is called lu and the air interface between the UTRAN and the UE is called Uu.

The UTRAN comprises radio network subsystems RNS. The interface between the RNSs is called lur. The RNS comprises a radio network controller RNC and one or more nodes B. The interface between the RNC and B is called lub. The coverage area, or cell, of the node B is marked with C in the figure.

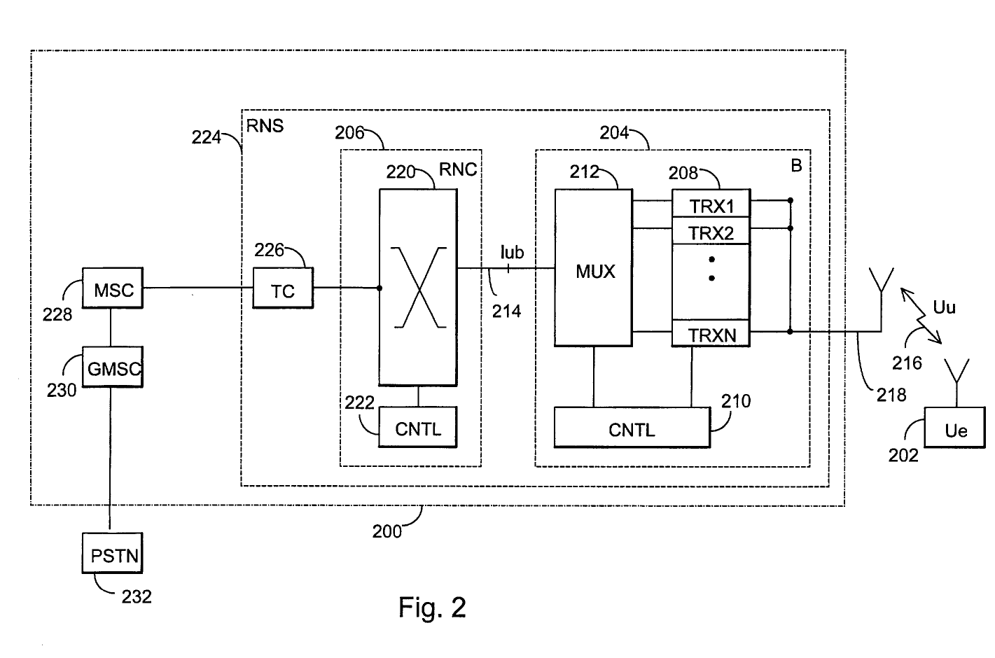

The description of FIG. 1 is relatively general, and it is clarified with a more specific example of a cellular radio system in FIG. 2. FIG. 2 includes only the most essential blocks, but it is obvious to a person skilled in the art that the conventional cellular radio system also includes other functions and structures, which need not be further explained herein. It is also to be noted that FIG. 2 only shows one exemplified structure. In systems according to the invention, details can be different from what is shown in FIG. 2, but as to the invention, these differences are not relevant.

A cellular radio network typically comprises a fixed network infrastructure, i.e. a network part 200, and user equipment 202, which may be fixedly located, vehicle-mounted or portable terminals. The network part 200 comprises base stations 204, a base station corresponding to a B-node shown in the previous figure. A plural number of base stations 204 are, in turn, controlled in a centralized manner by a radio network controller 206 communicating with them. The base station 204 comprises transceivers 208 and a multiplexer 212.

The base station 204 further comprises a control unit 210 which controls the operation of the transceivers 208 and the multiplexer 212. The multiplexer 212 arranges the traffic and control channels used by several transceivers 208 to a single transmission connection 214, which forms an interface lub.

The transceivers 208 of the base station 204 are connected to an antenna unit 218 which is used for implementing a bi-directional radio connection 216 to the user equipment 202. The structure of the frames to be transmitted in the bi-directional radio connection 216 is defined separately in each system, the connection being referred to as an air interface Uu.

The radio network controller 206 comprises a group switching field 220 and a control unit 222. The group switching field 220 is used for connecting speech and data and for combining signalling circuits. The base station 204 and the radio network controller 206 form a radio network subsystem 224 which further comprises a transcoder 226. The transcoder 226 is usually located as close to a mobile services switching centre 228 as possible, because speech can then be transferred in a cellular radio network form between the transcoder 226 and the radio network controller 206, which saves transmission capacity.

The transcoder 226 converts different digital speech coding forms used between a public switched telephone network and a radio network to make them compatible, for instance from a fixed network form to another cellular radio network form, and vice versa. The control unit 222 performs call control, mobility management, collection of statistical data and signalling.

FIG. 2 further shows the mobile services switching centre 228 and a gateway mobile services switching centre 230 which controls the connections from the mobile communications system to the outside world, in this case to a public switched telephone network 232.

The invention can thus be applied particularly to a system in which signal transmission is carried out by using ‘complex space-time block coding’ in which the complex symbols to be transmitted are coded to channel symbols in blocks having the length of a given K in order to be transmitted via several different channels and two or more antennas. These several different channels can be formed of different time slots. As a result of the coding, the symbol block forms into a code matrix in which the number of columns corresponds to the number of antennas used for the transmission and the number of rows corresponds to the number of different channels, which, in case of space-time coding, is the number of time slots to be used. Correspondingly, the invention can be applied to a system in which different frequencies or different spreading codes are used instead of time slots. In this case it does not naturally deal with space-time coding but rather with space-frequency coding or space-code-division coding. The space-frequency coding could be used in an OFDM (orthogonal frequency division multiplexing) system, for example.

Let us first examine the forming of a freely selected square complex space-time block code. Assuming the number of transmit antennas is N=2^{K-1}, where K is an integer and bigger than two. By means of the obtained code, K complex number modulated symbols can be transmitted during N symbol periods. These symbols can be marked with zₖ, k=1, . . . K.

A square complex space-time block code is based on a unitary N×N matrix, whose elements depend on linearly transmitted symbols zₖ and their complex conjugates. A unitary matrix is a square matrix whose inverse matrix is proportional to its hermitean conjugate. On the other hand, the hermitean conjugate is the complex conjugate of the matrix transpose. In addition, the proportional coefficient between the product of the code matrix and its hermitean conjugate, and the unit matrix is a linear combination of the absolute value squares of the symbols to be transmitted. This linear combination can be called unitarity coefficient. By interpreting the symbols to be transmitted appropriately, this linear combination can always be seen as a sum of the absolute value squares of the symbols to be transmitted.

By multiplying by a unitary N×N matrix, a square space-time block code which is freely selected from the left can be brought to a form in which the real part of a symbol to be transmitted appears only on the diagonal of the code matrix. If the symbols to be transmitted are interpreted in the above manner, said real part appears in every diagonal element, multiplied by the same real number. In this case, the dependence of the code matrix on the real part of the symbol is proportional to an N-dimensional unit matrix.

Let us next examine a method in which a unitary N×N matrix is formed, the elements of which depend linearly on symbols zₖ, the unitarity coefficient of which is proportional to the sum of the absolute value squares of the symbols zₖ and the dependence of which on the real part of a symbol zₗ is proportional to an N-dimensional unit matrix.

Let us take a freely selected 2K−1 quantity of N×N matrices, which are all antihermitean and unitary and which all anticommute with each other. An antihermitean matrix refers to a matrix, the hermitean conjugate of which is the matrix itself multiplied by −1. Anticommutation means that when two matrices can be multiplied by each other in two orders, then if one product is −1 times the other product, the matrices anticommute. The above family, to which 2K−1 matrices belong, can be called an N-dimensional anticommutator algebra presentation of 2K−1 elements.

Let us form K−1 pairs of these 2K−1 matrices. Since there is an uneven number of matrices, an N-dimensional unit matrix is used to form a pair with the remaining matrix. Two matrices are formed of each matrix pair such that the second matrix of the pair, multiplied by the imaginary unit, is added to and subtracted from the first matrix of the pair. The unit matrix is interpreted in its own pair as the first matrix. This way, 2K matrices are formed. These matrices form a complexified anticommutator algebra extended by a unit element. In short they are called complex anticommutator matrices.

A code matrix is formed such that each of the matrices formed as above defines the dependence of the code matrix on one and only one zₖ or the complex conjugate of zₖ. Thus, the code matrix is the sum of 2K elements, and each element is the product of some zₖ or zₖ complex conjugate and an N×N complex anticommutator matrix, such that each symbol, complex conjugate and matrix only appears once in the expression.

Let us examine a method of forming an N-dimensional anticommutator algebra presentation of 2K−1 elements.

First, three 2×2 matrices are freely selected, the matrices fulfilling the following conditions:

matrices are antihermitean and unitary

matrices anticommute with each other. So, the matrices form an anticommutator algebra presentation of the freely selected 3 elements. Two matrices are selected from the above defined matrices, and they can be called an elementary pair. The remaining matrix is multiplied by the imaginary unit, and the result is called a third elementary matrix. In addition, a matrix proportional to a two-dimensional unit matrix is used as a fourth elementary matrix. This matrix can be called an elementary unit matrix.

K−I pairs of N×N matrices are formed of these matrices by formulating tensor products of K−1 elementary matrices for example in the following manner:

The first matrix pair is established as a tensor product of K−2 elementary unit matrices and members of the elementary pair. Each member of the elementary pair appears as separately tensored with the unit matrices. This gives two matrices, i.e. a matrix pair.

The second matrix pair is obtained by tensoring K−3 elementary matrices, one member of the elementary pair and the third elementary matrix, in this order.

The Ith matrix pair is obtained by tensoring K−I−1 elementary unit matrices, one member of the elementary pair and I−1 third elementary matrices, in this order.

K−1th pair is obtained by tensoring one member of the elementary pair and K−2 third elementary matrices.

The tensor product of two matrices can be understood as a block form by considering a matrix with as many blocks as the first matrix to be tensored has elements, each block being as big as the second matrix to be tensored. A block of the tensor product is the corresponding element of the first matrix times the second matrix.

In the above manner we arrive at 2K−2 N-dimensional complex anticommutator matrices, where N=2^{K-1}. The 2K−1th anticommutator matrix is obtained by tensoring K−1 third elementary matrices and by multiplying by the imaginary unit.

Let us next examine an example of the above method. The following antihermitean unitary 2×2 matrices anticommuting with each other are selected:

$${σ}_{1} = ( \begin{matrix}0 & 1 \\ - 1 & 0\end{matrix} ) ; {σ}_{2} = ( \begin{matrix}0 & i \\ i & 0\end{matrix} ) ; τ = \begin{matrix} & & & \end{matrix} .$$

Here the imaginary unit is marked with the letter i. Let us call the pair σ₁, σ₂ an elementary pair and the matrix σ₃=iτ as a third elementary matrix. As a fourth elementary matrix, a 2-dimensional unit matrix

$${1}_{2} = ( \begin{matrix}1 & 0 \\ 0 & 1\end{matrix} )$$

is used, which is called an elementary unit matrix.

N=2^{K-1}-dimensional complex anticommutator matrices are formed as tensor products of the elementary matrices:

$$\begin{matrix}{γ}_{2} = {\underbrace{{1}_{2} ⊗ {1}_{2} ⊗ {1}_{2} ⊗ … ⊗ {1}_{2}}}_{K \text{-} 2 times} ⊗ {σ}_{1} \\ {γ}_{3} = {\underbrace{{1}_{2} ⊗ {1}_{2} ⊗ {1}_{2} ⊗ … ⊗ {1}_{2}}}_{K \text{-} 2 times} ⊗ {σ}_{2} \\ {γ}_{4} = {\underbrace{{1}_{2} ⊗ {1}_{2} ⊗ {1}_{2} ⊗ … ⊗ {1}_{2}}}_{K \text{-} 3 times} ⊗ {σ}_{1} ⊗ {σ}_{3} \\ {γ}_{5} = {\underbrace{{1}_{2} ⊗ {1}_{2} ⊗ {1}_{2} ⊗ … ⊗ {1}_{2}}}_{K \text{-} 3 times} ⊗ {σ}_{2} ⊗ {σ}_{3} \\ {γ}_{6} = {\underbrace{{1}_{2} ⊗ {1}_{2} ⊗ {1}_{2} ⊗ … ⊗ {1}_{2}}}_{K \text{-} 4 times} ⊗ {σ}_{1} ⊗ {σ}_{3} ⊗ {σ}_{3} \\ {γ}_{7} = {\underbrace{{1}_{2} ⊗ {1}_{2} ⊗ {1}_{2} ⊗ … ⊗ {1}_{2}}}_{K \text{-} 4 times} ⊗ {σ}_{2} ⊗ {σ}_{3} ⊗ {σ}_{3} \\ ⋮ \\ {γ}_{2 k} = {\underbrace{{1}_{2} ⊗ {1}_{2} ⊗ {1}_{2} ⊗ … ⊗ {1}_{2}}}_{K \text{-} 1 \text{-} k times} ⊗ {σ}_{1} {\underbrace{⊗ {σ}_{3} ⊗ … ⊗ {σ}_{3}}}_{k \text{-} 1 times} \\ {γ}_{2 k + 1} = {\underbrace{{1}_{2} ⊗ {1}_{2} ⊗ {1}_{2} ⊗ … ⊗} {1}_{2}}_{K \text{-} 1 \text{-} k times} ⊗ {σ}_{2} {\underbrace{⊗ {σ}_{3} ⊗ … ⊗ {σ}_{3}}}_{k \text{-} 1 times} \\ ⋮ \\ {γ}_{2 K - 2} = {σ}_{1} {\underbrace{⊗ {σ}_{3} ⊗ … ⊗ {σ}_{3}}}_{K \text{-} 2 times} \\ {γ}_{2 K - 1} = {σ}_{2} {\underbrace{⊗ {σ}_{3} ⊗ … ⊗ {σ}_{3}}}_{K \text{-} 2 times} \\ {γ}_{1 } = i {σ}_{3} {\underbrace{⊗ {σ}_{3} ⊗ … ⊗ {σ}_{3}}}_{K \text{-} 1 times}\end{matrix} \qquad ( 1 )$$

The formed matrices are an example of a 2K−1 quantity of N =2^{K-1}-dimensional antihermitean unitary matrices anticommuting with each other.

From these matrices, 2K complex anticommutator matrices

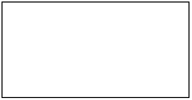

are formed in the following way:

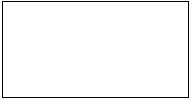

Matrices γₖ defined above are used herein. In addition, the 2^{K-1}-dimensional unit matrix is marked with γ₀. The matrices have also been normalized by dividing by two. The code matrix can now be formed for example as follows:

$$C = {\sum }_{k = 1}^{K} ( \begin{matrix} & \\ & \end{matrix} {γ}_{k -} + \begin{matrix} & \\ & \end{matrix} {γ}_{k +} ) \qquad ( 2 )$$

The obtained code is a delay optimal basic block code. All possible basic block codes of a given code rate can be created simply by interchanging the places of rows and/or columns in all γ matrices simultaneously, or by multiplying the γ matrices by any combination of terms, or changing the numbering of the γ matrices, or by multiplying all γ matrices from right and/or left by a unitary matrix which has four elements diverging from zero, the elements being an arbitrary combination of the numbers ±1, ±i.

For example, the basic rate ¾ code for four transmit antennas as formed in the above manner has the form

$$( {z}_{1} , {z}_{2} , {z}_{3} ) \to ( \begin{matrix}{z}_{1} & {z}_{2} & {z}_{3} & 0 \\ - {z}_{2}^{*} & {z}_{1}^{*} & 0 & - {z}_{3} \\ - {z}_{3}^{*} & 0 & {z}_{1}^{*} & {z}_{2} \\ 0 & {z}_{3}^{*} & - {z}_{2}^{*} & {z}_{1}\end{matrix} ) \qquad ( 3 )$$

Here N=4 and K=3. Further, the rate ½ code for eight antennas, for example, is

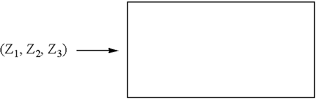

Here the rate ¾ code is in the upper left corner and the corresponding inverted complex conjugate in the lower right corner.

By the above manner, ‘basic codes’ are obtained, in which the elements only depend on one signal, or the real part of one signal and the imaginary part of another. The combination of any N′≦N code matrix column gives a full diversity non-square code for N′ antennas. Using these codes, full diversity codes, which do not have the above restriction, can be constructed in the solution of the invention. In a solution according to a preferred embodiment of the invention the elements are allowed to be linear combinations. This way, provided that full diversity is provided, block codes that are unitarily converted are obtained, having the form

\overline{C}=UC(z)V, (4)

where C(z) is a basic block code, such as above. It is an N×N′ matrix, where N is the number of time slots and N′ is the number of antennas. U and V are N×N and N′×N′ unitary matrices. The phase shifts caused by U and V are irrelevant. U and V can be assumed to be unitary matrices with determinant 1.

This construction gives a family of block codes with N²+N′² −2 continuous parameters. The square codes obtained this way comprise delay optimal maximal rate block codes when the number of antennas is proportional to a power of two.

Consider, for example, the rate ¾ code for four antennas which were described above (3). A generic unitary 4×4 matrix with a unit determinant can be written, for example, as

$$V = exp \frac{i}{2} ( \begin{matrix}{Φ}_{13} + \frac{1}{\sqrt{3}} {Φ}_{14} + \frac{1}{\sqrt{6}} {Φ}_{15} & {w}_{1} & {w}_{2} & {w}_{3} \\ {w}_{1}^{*} & - {Φ}_{13} + \frac{1}{\sqrt{3}} {Φ}_{14} + \frac{1}{\sqrt{6}} {Φ}_{15} & {w}_{4} & {w}_{5} \\ {w}_{2}^{*} & {w}_{4}^{*} & \frac{- 2}{\sqrt{3}} {Φ}_{14} + \frac{1}{\sqrt{6}} {Φ}_{15} & {w}_{6} \\ {w}_{3}^{*} & {w}_{5}^{*} & {w}_{6}^{*} & \frac{- 3}{\sqrt{6}} {Φ}_{15}\end{matrix} ) \qquad ( 5 )$$

where the exp operation is a matrix exponential, the six parameters ωⱼ, j=1, . . . , 6 are complex and the three parameters Φⱼ , j=1, . . . , 3, are real. U is of the same form. All in all this makes 30 free real parameters. All possible generalizations of said ¾ code (3) can now be constructed by applying the transformation (4) and using the above described U and V.

It would be desirable that transmission power is distributed equally between different antennas. However, when for example the prior art ¾ code (the ¾ code mentioned in the introduction of the application, for instance) is used, some antennas transmit using only half of their power at certain times. If the code (3) according to a preferred embodiment of the invention is used, the ratio of the peak power to the average power can be made lower. In addition, this construction allows that instead of transmitting zeros of the code matrix, a signal that is orthogonalized in some other way (for example by a different spreading code), a pilot signal for instance, can be transmitted. This way a fully power-uniformized transmission can be provided.

In a system with several users, especially in a code division and frequency division system, users can be provided with different versions (for example, a version with a permutated antenna order) of the block code, and thus the transmission powers can be uniformized.

Sometimes, in a time division system with several users, for example, it is preferable to balance the transmission of one user directly without using the above mentioned ways. In a solution according to a preferred embodiment of the invention, an unequal distribution of transmission power between different antennas can be avoided and the above described unitary transformation (4) is applied. The power spectrum of different antennas cannot necessarily be uniformized in respect to each other as a function of time, but by selecting the unitary transformation preferable, the average transmission powers of the antennas are uniformized and the ratio of the peak power to the average power and the ratio of the minimum power to the average power can be minimized.

Let us examine this embodiment by means of an example. Consider the above described ¾ code (3) for four antennas. Depending on which parameter needs to be improved, the matrices U and V are selected in an appropriate manner. If the minimum-to-average power needs to be optimized, V is selected as the unit matrix and U as the 4×4 Hadamard matrix:

$$U = \frac{1}{2} ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )$$

Now by applying the transformation (4) to the code (3) with the above mentioned matrices U and V, the power-uniformized code is

$$\overline{C} = UC ( z ) = ( \begin{matrix}{z}_{1} - {z}_{2}^{*} - {z}_{3}^{*} & {z}_{1}^{*} + {z}_{2}^{*} + {z}_{3}^{*} & {z}_{1}^{*} - {z}_{2}^{*} + {z}_{3}^{*} & {z}_{1} + {z}_{2} - {z}_{3} \\ {z}_{1} + {z}_{2}^{*} - {z}_{3}^{*} & - {z}_{1}^{*} + {z}_{2}^{*} - {z}_{3}^{*} & {z}_{1}^{*} + {z}_{2}^{*} + {z}_{3}^{*} & - {z}_{1} + {z}_{2} + {z}_{3} \\ {z}_{1} - {z}_{2}^{*} + {z}_{3}^{*} & {z}_{1}^{*} + {z}_{2}^{*} - {z}_{3}^{*} & - {z}_{1}^{*} + {z}_{2}^{*} + {z}_{3}^{*} & - {z}_{1} - {z}_{2} - {z}_{3} \\ {z}_{1} + {z}_{2}^{*} + {z}_{3}^{*} & - {z}_{1}^{*} + {z}_{2}^{*} + {z}_{3}^{*} & - {z}_{1}^{*} - {z}_{2}^{*} + {z}_{3}^{*} & {z}_{1} - {z}_{2} + {z}_{3}\end{matrix} ) . \qquad ( 6 )$$

On the other hand, if the peak-to-average power needs to be minimized, U and V can be selected for example as follows: (It is assumed herein that the signal constellation is 8-PSK.)

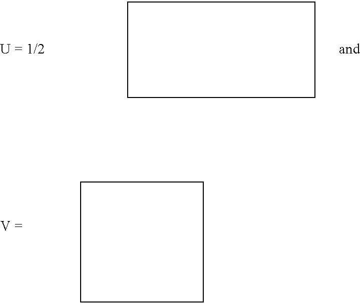

Applying now the transformation (4) to the code (3) with the above matrices U and V, a power-uniformized code is achieved, which has a minimal peak-to-average power

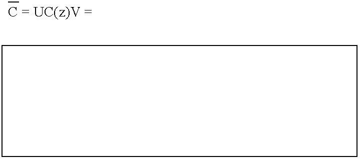

Let us next examine a decoding method which can be applied to the reception of the signals that are coded in the above manners. Let us assume that a receiver has M antennas. Let us further assume that N′ antennas are used for transmission in a transmitter and that the block code uses N time slots. The channel between the nth transmit antenna and the mth receive antenna is denoted by the term αₙₘ. The channels can be assumed to be static over the frame N. The channel terms are collected into the N′×M matrix

$$α = ( \begin{matrix}{α}_{11} & {α}_{12} & ⋯ & {α}_{1 M} \\ {α}_{21} & {α}_{22} & ⋯ & {α}_{2 M} \\ ⋮ & ⋮ & ⋰ & ⋮ \\ {α}_{N1} & {α}_{N2} & ⋯ & {α}_{NM}\end{matrix} )$$

Correspondingly, the signal received by the antenna m at the time slot t is denoted by rₜₘ. The N×M matrix of these signals is obtained from the formula

R=\overline{C}(z)α+noise,

where noise is an N×M matrix of additive complex Gaussian noise. The block code \overline{C} is constructed as above ((1), (2) and (4)), possibly by restricting the number of antennas. Now denote

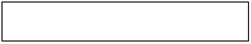

Using these markings, the maximum likelihood detection metric for the kth transmitted symbol zₖ is

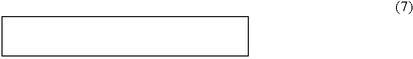

where Tr refers to a matrix trace, i.e. the sum of diagonal elements, and H refers to the complex conjugate transpose. Thus, the aim is to minimize the metric, i.e. it is used as a criterion for deciding which symbol zₖ comprises.

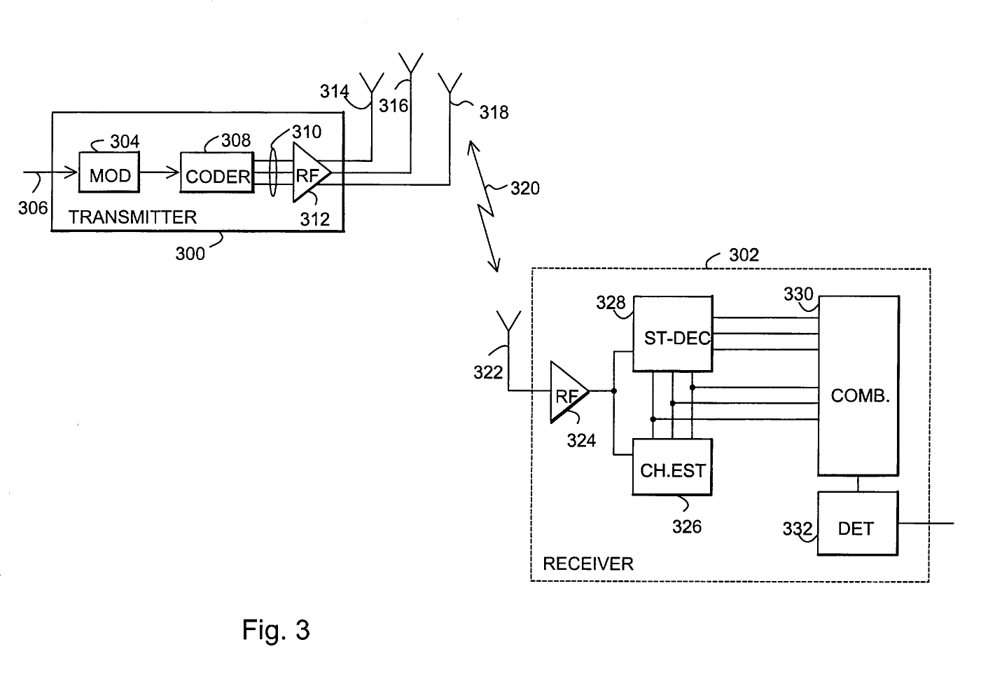

FIG. 3 illustrates an example of an arrangement according to an embodiment of the invention. The figure shows a situation where channel-coded symbols are transmitted via three antennas at different frequencies, at different time slots or by using a different spreading code. Firstly, the figure shows a transmitter 300, which is in connection with a receiver 302. The transmitter comprises a modulator 304 which receives as input a signal 306 to be transmitted, which consists of bits in a solution according to a preferred embodiment of the invention. The bits are modulated to symbols in the modulator. The symbols to be transmitted are grouped into blocks having the length of a given K. It is assumed in this example that the length of the block is three symbols and that the symbols are z₁, Z₂ and z₃. The symbols are conveyed to a coder 308. In the coder each block is coded to N×N′ channel symbols. The channel symbols 310 are conveyed in this example via radio frequency parts 312 to three antennas 314 to 318 from where they are to be transmitted.

In the present example, the block comprises the symbols z₁, z₂ and z₃. The coder performs coding, the defining code matrix of which is formed of 2K elements, in which each element is a product of a symbol or symbol complex conjugate to be transmitted and a complex N×N anticommutator matrix, and in which each matrix is used at most once in the formation of the code matrix.

A code matrix can for example be the matrix (6) described above, which means that the coder performs the coding

$$( {z}_{1} , {z}_{2} , {z}_{3} ) \to ( \begin{matrix}{z}_{1} - {z}_{2}^{*} - {z}_{3}^{*} & {z}_{1}^{*} + {z}_{2}^{*} + {z}_{3}^{*} & {z}_{1}^{*} - {z}_{2}^{*} + {z}_{3}^{*} & {z}_{1} + {z}_{2} - {z}_{3} \\ {z}_{1} + {z}_{2}^{*} - {z}_{3}^{*} & - {z}_{1}^{*} + {z}_{2}^{*} - {z}_{3}^{*} & {z}_{1}^{*} + {z}_{2}^{*} + {z}_{3}^{*} & - {z}_{1} + {z}_{2} + {z}_{3} \\ {z}_{1} - {z}_{2}^{*} + {z}_{3}^{*} & {z}_{1}^{*} + {z}_{2}^{*} - {z}_{3}^{*} & - {z}_{1}^{*} + {z}_{2}^{*} + {z}_{3}^{*} & - {z}_{1} - {z}_{2} - {z}_{3} \\ {z}_{1} + {z}_{2}^{*} + {z}_{3}^{*} & - {z}_{1}^{*} + {z}_{2}^{*} + {z}_{3}^{*} & - {z}_{1}^{*} - {z}_{2}^{*} + {z}_{3}^{*} & {z}_{1} - {z}_{2} + {z}_{3}\end{matrix} ) .$$

The coder can preferably be implemented by means of a processor and suitable software or alternatively by means of separate components.

Let us examine the receiver shown in FIG. 3 once more. By means of the transmitter of the invention, a signal 320 is transmitted by using three or more antennas. The signal is received in the receiver 302 by means of an antenna 322 and it is conveyed to the radio frequency parts 324. The number of antennas in the receiver is not relevant for the invention. In the radio frequency parts the signal is converted to an intermediate frequency or to baseband. The converted signal is conveyed to a channel estimator 326, which forms estimates for the channel through which the signal has propagated. The estimates can be formed, for example, by means of previously known bits the signal contains, such as a pilot signal or a training sequence code. The signal is conveyed from the radio frequency parts also to a combiner 330, to which also the estimates are delivered from the channel estimator 326. The channel estimator and the radio frequency parts can be implemented by employing the known methods.

The combiner 330 receives the symbols transmitted at different time slots, typically stores them temporarily in a buffer memory and forms estimates □, i=1,2,3 for the original block symbols by means of the channel estimates and the metric (7). A detector 332 performs the symbol detection according to the formula (7). The signal is conveyed from the detector 332 to a channel decoder and further to the other parts of the receiver. The detector can preferably be implemented by means of a processor and suitable software or alternatively by means of separate components.

Only one example of a possible receiver is described above. The calculation and use of channel estimates, for example, can be implemented in various other ways, as is obvious to a person skilled in the art.

Although the invention has been described above with reference to the examples according to the attached drawings, it is obvious that the invention is not restricted thereto, but may be modified in a variety of ways within the scope of the attached claims.

1. A method of transmitting a digital signal consisting of symbols, which method comprises the steps of coding complex symbols to channel symbols in blocks having the length of a given K and transmitting the channel symbols via several different channels and two or more antennas, the method comprising
performing the coding such that the coding is defined by a code matrix, which can be expressed as a sum of 2K elements, in which each element is a product of a symbol or symbol complex conjugate to be transmitted and a N×N representation matrix of a complexified anticommutator algebra, extended by a unit element, and in which each matrix is used at most once in the formation of the code matrix.

2. A method of transmitting a digital signal consisting of symbols, which method comprises the steps of coding complex symbols to channel symbols in blocks having the length of a given K and transmitting the channel symbols via several different channels and two or more antennas, the method comprising
performing the coding such that the coding is defined by a code matrix which is formed by freely selecting 2K−1 unitary, antihermitean N×N matrices anticommuting with each other,
forming K−1 pairs of said matrices, whereby the remaining matrix forms a pair with an N-dimensional unit matrix,
forming two matrices of each pair such that the second matrix of the pair, multiplied by the imaginary unit, is added to and subtracted from the first matrix of the pair,
and in which method each matrix formed in the above manner defines the dependence of the code matrix on one symbol or symbol complex conjugate to be coded.

3. A method as claimed in claim 1 or 2, where in the signal coding comprises negation and repetition of at least some symbols.

4. A method as claimed in claim 1 or 2, further comprising the step of transmitting the channel symbols, divided into several time slots, via two or more antennas.

5. A method as claimed in claim 1 or 2, further comprising the step of transmitting the channel symbols, divided into several frequencies, via two or more antennas.

6. A method as claimed in claim 1 or 2, further comprising the step of transmitting the channel symbols, multiplied by several spreading codes, via two or more antennas.

7. A method as claimed in claim 1 or 2, further comprising the step of multiplying the code matrix by unitary matrices either from the left or from the right.

8. A method as claimed in claim 1 or 2, further comprising the step of multiplying the code matrix by unitary matrices from the left and from the right.

9. A method as claimed in claim 7, further comprising the step of selecting the unitary matrices such that the power levels of the antennas used in the signal transmission are equally high on the average.

10. A method as claimed in claim 7, further comprising the step of selecting the unitary matrices such that the difference between the highest and the lowest power level of the antennas used in the signal transmission is as small as possible.

11. A method as claimed in claim 7, further comprising the step of selecting the unitary matrices such that the difference between the power level peak value and the power level average value of the antennas used in the signal transmission is as small as possible.

12. A method as claimed in claim 4, where in the number of antennas is N at the most and the number of time slots is N.

13. A method as claimed in claim 4, where in the number of antennas is N at the most and the number of frequencies is N.

14. A method as claimed in claim 4, where in the number of antennas is N at the most and the number of spreading codes is N.

15. A method as claimed in claim 1, where in the number of transmit antennas is the same as the number of columns in the code matrix.

16. A method as claimed in claim 1, 2 or 15, further comprising the step of deleting one or more columns from the code matrix.

17. A method as claimed in claim 1 or 2, where in the code matrix includes zero elements.

18. A method as claimed in claim 1, further comprising the steps of transmitting at least two parallel channels simultaneously and implementing the power uniformization between the channels by permutating the antennas in the code matrix.

19. A method as claimed in claim 17, further comprising the steps of transmitting at least two parallel channels simultaneously and implementing the power uniformization between the channels such that instead of transmitting zeros of the code matrix, orthogonalized information is transmitted.

20. An arrangement for transmitting a digital signal consisting of symbols, which arrangement comprises a coder for coding complex symbols to channel symbols in blocks having the length of a given K, means for transmitting the channel symbols via several different channels and two or more antennas, where in
the coder is arranged to code the symbols using a code matrix, which can be expressed as a sum of 2K elements, in which each element is a product of a symbol or symbol complex conjugate to be transmitted and a N×N representation matrix of a complexified anticommutator algebra, extended by a unit element, and in which each matrix is used at most once in the formation of the code matrix.

21. An arrangement for transmitting a digital signal consisting of symbols, which arrangement comprises a coder for coding complex symbols to channel symbols in blocks having the length of a given K, means for transmitting the channel symbols via several different channels and two or more antennas, where in
the coder is arranged to code the symbols using a code matrix which is formed by freely selecting 2K−1 unitary, antihermitean N×N matrices anticommuting with each other, forming K−1 pairs of said matrices, whereby the remaining matrix forms a pair with an N-dimensional unit matrix, forming two matrices of each pair such that the second matrix of the pair, multiplied by the imaginary unit, is added to and subtracted from the first matrix of the pair, and in which each matrix formed in the above manner defines the dependence of the code matrix on one symbol or symbol complex conjugate to be coded.

22. An arrangement as claimed in claim 20 or 21, where in that the arrangement comprises the means for transmitting the channel symbols, divided into several time slots, via two or more antennas.

23. An arrangement as claimed in claim 20 or 21, where in the arrangement comprises the means for transmitting the channel symbols, divided into several frequencies, via two or more antennas.

24. An arrangement as claimed in claim 20 or 21, where in the arrangement comprises the means for transmitting the channel symbols, multiplied by several spreading codes, via two or more antennas.

25. An arrangement as claimed in claim 22, where in the number of antennas is N at the most and the number of time slots is N.

26. An arrangement as claimed in claim 23, where in the number of antennas is N at the most and the number of frequencies is N.

27. An arrangement as claimed in claim 24, where in the number of antennas is N at the most and the number of spreading codes is N.

28. An arrangement as claimed in claim 20 or 21, where in the number of transmit antennas is the same as the number of columns in the code matrix.

29. An arrangement as claimed in claim 20 or 21, where in the coder is arranged to code the symbols by using the code matrix from which one or more columns are deleted.
